(19) United States
(12) Patent Application Publication
(10) Pub. No.: US 2008/0294701 A1
(43) Pub. Date: Nov. 27, 2008

(54) ITEM-SET KNOWLEDGE FOR PARTIAL REPLICA SYNCHRONIZATION

(75) Inventors: Venugopalan Ramasubramanian Saraswati, Mountain View, CA (US); Thomas L. Rodeheffer, Mountain View, CA (US); Douglas Terry, San Carlos, CA (US); Edward P. Wobber, Menlo Park, CA (US)

Correspondence Address: VIERRA MAGEN/MICROSOFT CORPORATION, 575 MARKET STREET, SUITE 2500, SAN FRANCISCO, CA, 94105, US

(73) Assignee: MICROSOFT CORPORATION, Redmond, WA (US)

(21) Appl. No.: 11/751,478

(22) Filed: May 21, 2007

(51) Int. Cl. G06F 17/30

(52) U.S. Cl. 707/203; 707/E17.005

(57) ABSTRACT

A system is disclosed for synchronizing partially-replicated collections while keeping synchronization overhead low by using the concept of item-set knowledge. Item-set knowledge uses knowledge fragments, which associate knowledge vectors with item-sets. An item-set consists of an explicitly represented list of items. In a partial replica, this item set may be the items known to a replica within which a filter is applied limiting the items known to some subset of the overall items in the collection.

### BACKGROUND

In a collection of computing devices, a data item may be multiply replicated to create a number of copies of the item on the different computing devices and/or possibly within a single device. An item may be any stored data object, such as for example contact or calendar information, stored pictures or music files, software application programs, files or routines, etc. The collection of computing devices may for example be a desktop computer, a remote central server, a personal digital assistant (PDA), a cellular telephone, etc. The group of all such items and replicas where the items are stored may be referred to as a distributed collection.

In many cases, a user would like all of their various data storing devices to have the latest updated information without having to manually input the same changes into each device data store. Replication, or synchronization, of data is one process used to ensure that each data store has the same information. Synchronization protocols are the means by which devices exchange created and updated versions of items in order to bring themselves into a mutually consistent state. The periodicity of the sync may vary greatly. Networked devices may sync with each other frequently, such as once every minute, hour, day, etc. Alternatively, devices may sync infrequently, such as for example where a portable computing device is remote and disconnected from a network for a longer period of time. Whether the synchronization is frequent or infrequent, the distributed collection is said to be weakly-consistent in that, in any given instant, devices may have differing views of the collection of items because items updated at one device may not yet be known to other devices.

As an example, a user may maintain an electronic address book or a set of email messages in a variety of different devices or locations. The user may maintain the address book or email addresses, for example, on a desktop computer, on their laptop computer, on a personal digital assistant (PDA) and/or mobile phone. The user may modify the contact information or send/receive email addresses using applications associated with each location. Regardless of where or how a change is made, one goal of replication is to ensure that a change made on a particular device or in a particular location is ultimately reflected in the data stores of the other devices and in the other locations.

FIG. 1 illustrates a weakly-consistent distributed collection, including multiple replicas A-F. Each replica A-F may be a computing device including a data store and associated processor. However, as is known, a single computing device may include several replicas, and a single replica may be implemented using more than one computing device. In the example of FIG. 1, the replicas may include a desktop computer A, a pair of laptop computers B and C, a cellular telephone D, a personal digital assistant (PDA) E and a digital camera F. The number and type of replicas is by way of example and may be more, less and/or different than shown. FIG. 1 further shows communication links 22 (represented by dashed lines) between the various replicas to establish a peer-to-peer network. It may often be the case that not all replicas are linked to all other replicas. For example, laptop B is linked to desktop A, laptop C, cellular phone D and PDA E, but not digital camera F. Consequently, laptop B can sync with digital camera F only through one or more intermediate sync steps with replicas A and C through E. The illustrated communication links can be wired and/or wireless links.

Synchronization between replicas may be described as a sharing of knowledge between replicas. A common knowledge sharing scheme involves tracking, within each replica, changes that have occurred to one or more items subsequent to a previous replication. One such tracking scheme makes use of version vectors, which consist of list of version numbers, one per replica, where each version number is an increasing count of updates made to an item by a replica. During synchronization, one replica sends version vectors for all of its stored items to another replica, which uses these received version vectors to determine which updated items it is missing. Comparing the version vectors of two copies of an item tells whether one copy is more up-to-date (every version number in the up-to-date copy is greater than or equal to the corresponding version number in the other copy) or whether the two copies conflict (the version vectors are incomparable). The replica may then update its copy of the item if required or make efforts to resolve the detected conflict.

Although version vectors enable replicas to synchronize correctly, they introduce overhead. The version vector of each item may take O(N) space in an N replica replication system, thus requiring O(M*N) space across an M item collection. This space requirement could be substantial if the number of items is large and could approach the size of the items themselves if items are small. Similarly, exchanging version vectors during synchronization consumes bandwidth. Even if two replicas have fully consistent data stores, they still need to send a complete list of version vectors whenever they periodically perform synchronization.

Another knowledge sharing scheme, implemented for example in the WinFS data storage and management system from Microsoft Corp., makes use of knowledge vectors. Unlike version vectors, knowledge vectors are associated with the replicas rather than the items. Each replica keeps a count of the updates it generates, and the knowledge vector of a replica consists of the version number of the latest update it learned from every other replica. In addition, items at a replica have a single version number indicating the latest update applied to it. Replicas exchange knowledge vectors during synchronization, determine and exchange the missing updates, and change their knowledge vector to reflect the newly-learned knowledge (each number is set to the maximum of the corresponding numbers in the two knowledge vectors of the synchronizing replicas).

An example of knowledge sharing between a pair of replicas using knowledge vectors is illustrated with respect to prior art FIGS. 2 and 3. In the example of FIGS. 2 and 3, replica A is synching with replica B. Replica A has a data store 24 including a knowledge vector, K_{A}, and a set of replicated items. The knowledge vector in replica A includes one or more pairs of replica IDs together with update counters, which together represent what knowledge replica A has about changes that have occurred to items in the collection. For example, knowledge vector K_{A} may have the components:

K_{A}=A5 B3 C7.

This means that replica A has knowledge including changes up to the 5^{th} change in replica A, the 3^{rd} change in replica B, and the 7^{th} change in replica C.

Each of the changes indicated in the knowledge vector may be represented in the set of replicated items. For example, assume four items in the collection, identified by unique identifiers i, j, l and m. The set of items stored in data store 24 at Replica A may look as follows:

TABLE 1

| Item | | |
|---|---|---|
| Unique ID | Version | Data |
| i | A2 | . . . |
| j | C7 | . . . |
| l | A5 | . . . |
| m | B3 | . . . |

The data store thus indicates, for a given item, which version was produced when that item was last changed (i.e. the item was created, modified or deleted) as far as this replica is aware, and the data showing the actual updated contents (not shown in Table 1). Thus, for example, replica A knows that the 7^{th} change in replica C was to item j, and it includes the data associated with the change to item j.

Similarly, replica B has a data store 24 including a knowledge vector, K_{B}, and a set of replicated items. The knowledge vector in replica B represents what knowledge replica B has about changes that have occurred to items in the collection. For example, knowledge vector K_{B} may have the components:

K_{B}=A2 B5 C8.

This means that replica B has knowledge including changes up to the 2^{nd} change in replica A, the 5^{th} change in replica B and the 8^{th} change in replica C. Each of these changes is represented in the set of items stored by replica B.

Referring now to prior art FIG. 3, at time 1, replica A sends a sync request along with replica A's knowledge, which may be represented by replica A's knowledge vector, to replica B. At time 2, replica B examines replica A's knowledge by comparing the respective knowledge vectors. Replica B discovers that replica A is not aware of changes made by replica B that are labeled with the version B5, or changes made by replica C (which are known to replica B) that are labeled with the version C8. Thus, replica B sends the items with these versions. Subsequently or simultaneously as illustrated in time 3, replica B sends to replica A replica B's learned knowledge.

As this is a one-way synchronization, this ends the sync process resulting from replica A's sync request (in a two way sync, the process would be repeated with replica B receiving changes from replica A and learning what knowledge replica A has). Replica A can update its knowledge vector based on the learned knowledge and received changes to include the recently replicated changes as shown in Replica A in FIG. 3.

Knowledge vectors impose substantially lower overhead compared to version vectors. The space required per replica to store knowledge vectors is just O(N+M), including the space required for per item version numbers, compared to O(NM) for version vectors, where the system has N replicas and the replica has M items. Further more, exchanging knowledge vectors only requires O(N) bandwidth compared to O(NM) for exchanging version vectors.

While knowledge vectors work well for total replication between replicas, it may happen that one or more replicas are only interested in receiving a certain subset of information. This situation is referred to as partial replication. For example, suppose the data store includes email messages in various folders, including an inbox folder and some number of other folders including, perhaps, folders that contain saved email messages. In some cases a user might want to replicate changes to all of the email folders. For example, this might be desirable when the communications bandwidth between replicating devices is large. In other cases—perhaps when the bandwidth is limited, as it might be at some times with a mobile phone or PDA—the user might only want to replicate changes to a particular folder, like their inbox.

It is also conceivable that a user might want to synchronize only part of their entire set of data in all cases. For example, a user might want to maintain all email on a desktop computer or server, but only synchronize their inbox and a selected set of folders to a small device that has limited storage. In this case, some information may never be synchronized with a particular device.

As another example, consider a data store that includes digital music files. In some cases, a user might want to synchronize their entire digital music library—perhaps they have a portable music player or computer with a large hard drive. They may also have a small portable music player with a limited amount of flash memory, on which they only want to store a selected set of music. In one example, this music to be synchronized might include, for example, digital music files the user has rated with “four stars” or “five stars,” as well as music downloaded in the last week.

In order to allow for partial replication in the above situation, as well as a wide variety of others, a replica may contain a filter. A “filter” may be broadly defined as any construct that serves to identify a particular set of items in a data collection. When synchronizing in a partial replication scenario, like in the situations introduced above, various additional problems may occur. These problems include the following:

Efficient knowledge sharing: A partial replica is interested in only a certain subset of items and consequently has knowledge that is limited by its scope of interest. When a partial replica shares its knowledge with a second replica, the second replica must somehow account for this limitation. This is not a problem for a version vector knowledge sharing scheme, which maintains knowledge about each item separately. However, a knowledge vector knowledge sharing scheme maintains its knowledge vector about the replica as a whole rather than about each item separately. This results in a substantial savings in storage and bandwidth as compared with version vectors, but it also makes it a problem to account for a limited scope of interest.

Partial information: In order for a replica to eventually learn about an item of its interest, it requires a synchronization path to all other replicas that are interested in the same item. Moreover, each intermediate replica in the synchronization path must also be interested in the item. Otherwise, a replica may not receive complete information about all the items it is interested in. For example, in FIG. 1, if the camera E takes a picture that the cell phone C wants to use as a background but the laptop A and the PDA D are not interested in the picture then the cell phone C has no way of obtaining it with its existing synchronization topology.

Push outs: Second, it is desirable to ensure that items created in less reliable or storage constrained devices find durable storage in the system. For example, in FIG. 1, while a user might take a large number of pictures with a digital camera, it's convenient to find long-term storage for these pictures at a replica with large storage capacity. However, the camera can safely discard the local copy of a picture only if there are guarantees that the picture will be stored elsewhere. This is possible by transferring the picture to another replica during synchronization. However, ensuring such transfers eventually result in durable storage for the pictures is difficult with ad-hoc synchronization.

Move outs: Third, when an item moves out of scope of interest of a replica due to a modification, just discarding the item from the replica may lead to undesirable consequences. For example, in FIG. 1, suppose that the Laptop B and the cell phone C are involved in storing the calendar for weekend game schedules and Laptop B learns that a weekend game has moved to a week day. In that case, Laptop B may discard the schedule. However, this prevents the cell phone from learning about the move-out. Even if Laptop B keeps a place holder for the schedule after discarding it, the cell phone may not be able to tell if the move-out at B would also means a move-out for itself without matching the item with its filter.

Deletes: Fourth, the system needs to ensure that when a replica deletes an item, all copies of that item are permanently deleted from the system. If not, the deleted copy might get resurrected at a later point of time based on an old version. However, consistently figuring out when all knowledge about an item can be erased may require commitment by all the replicas in the system which is expensive in an ad-hoc synchronization topology for partial replication.

Filter Changes: Finally, replicas may change filters at any time causing some items to move out of the interest set as well as disrupt the path of information flow the replica relied on to learn new items. For example, in FIG. 1, if the laptop B changes its filter to exclude all pictures then other replicas in the system may have no way of receiving the pictures taken by the camera E (PDA D is not interested in pictures in the first place). It is desirable to ensure that filter changes do not disrupt information flow and items discarded during filter changes are completely expunged without the risk of resurrections.

Except for the problem of efficient knowledge sharing, a reason for the above problems is that arbitrary synchronization topologies do not provide a guaranteed path of information flow for replicas. A naive solution to provide guaranteed information paths is to have one or more replicas serve as reference replicas, which replicate all the items in the system, and have replicas synchronize with a reference replica periodically. However, it may not be always possible for all replicas to synchronize with reference replicas. Moreover, reference replicas may not be reachable at a dire time of need.

### SUMMARY

The present technology, roughly described, relates to a system for synchronizing partially-replicated collections while keeping synchronization overhead low by using the concept of item-set knowledge. Item-set knowledge consists of one or more knowledge fragments, which associate knowledge vectors with sets of items, called item-sets, instead of the whole replica. An item-set consists of an explicitly represented list of unique item identifiers. In a partial replica, this item-set may be the items known to a replica for which a filter is applied limiting the items known to some subset of the overall items in the collection.

Item-set knowledge forms a nice intermediate between the two extreme cases of per-item version vectors and per-replica knowledge vectors in terms of space and bandwidth consumption. In the best case, the item-set knowledge may require a single item-set to cover the knowledge of all the items in the replica, while in the worst case, it may require a separate item-set for each item in the replica.

Knowledge fragments are additive, i.e. a replica is aware of a specific version of a specific item if any of its knowledge fragments indicates that this is true. Each knowledge fragment consists of two parts: an explicit set of items (indicated by their globally unique identifiers or GUIDs) and an associated set of versions represented by a knowledge vector. The semantics are that, for any item in the item-set, the replica is aware of any versions included in the associated knowledge vector. A knowledge vector may include versions for items that are not in the associated item-set, in which case nothing can be concluded about these versions. In addition, similar to the knowledge vector scheme, the latest version number for the item may also need to be kept.

A replica initiating synchronization sends all of its knowledge fragments to the source replica, which returns, in addition to updated items, one or more knowledge fragments as learned knowledge. A partial replica may hold knowledge fragments both for items that it stores and that matches its filter, called “class I knowledge”, and for items that it knows does not match its filter, called “class II knowledge.”

### BRIEF DESCRIPTION OF THE DRAWINGS

FIG. 1 is weakly-consistent distributed collection according to the prior art.

FIG. 2 shows a pair of replicas A and B and their respective knowledge fragments according to the prior art.

FIG. 3 show a synchronization operation between replicas A and B according to the prior art.

FIG. 4 is weakly-consistent distributed collection including one or more partial replicas according to embodiments of the present system.

FIG. 5 shows a replica A including a knowledge fragment and a filter according to embodiments of the present system.

FIG. 6 shows a one-way synchronization operation between a pair of replicas A and B according to the present system.

FIG. 7 shows the replicas A and B of FIG. 6 after the one-way synchronization operation according to the present system.

FIG. 8 shows a one-way synchronization operation between a pair of replicas B and C according to the present system.

FIG. 9 shows the replicas B and C of FIG. 8 after the one-way synchronization operation and after a defragmentation of the knowledge fragment learned by replica B according to the present system.

FIG. 10 is a block diagram of a computing system environment according to an embodiment of the present system.

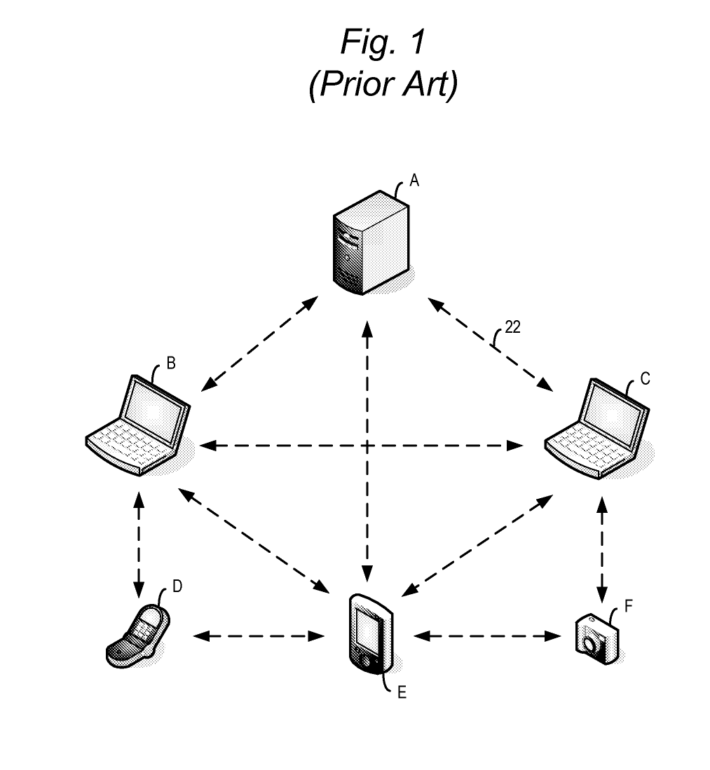

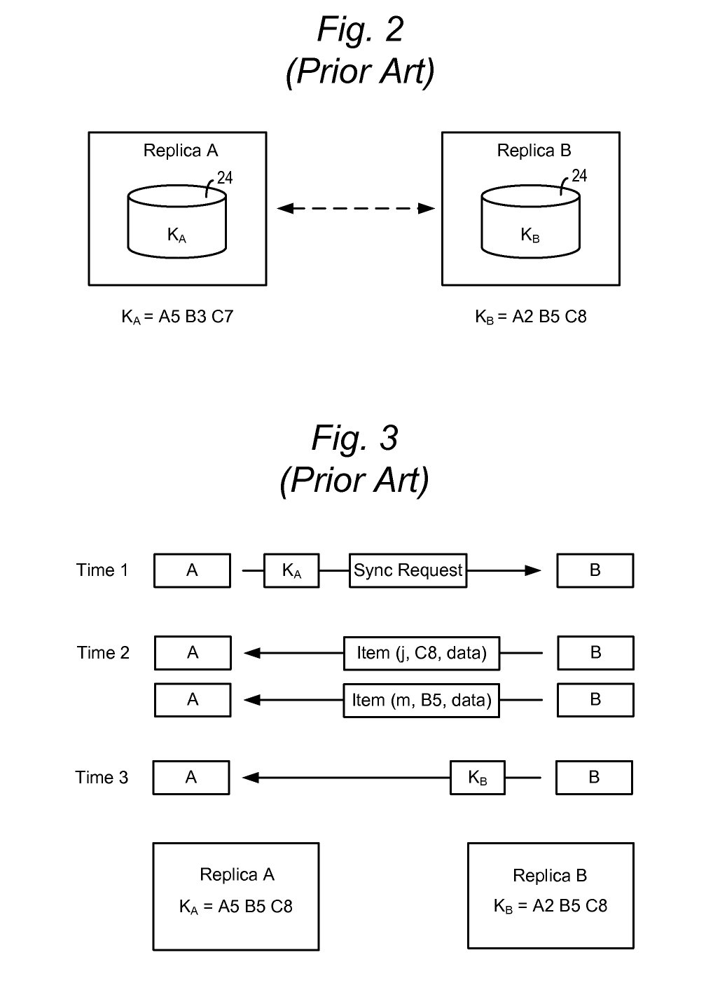

### DETAILED DESCRIPTION

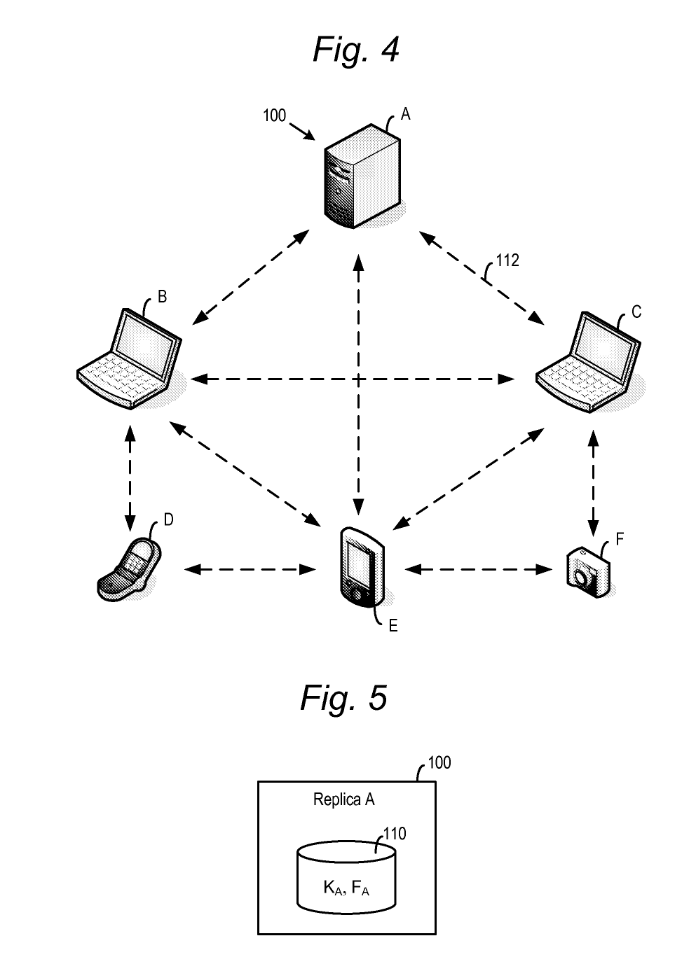

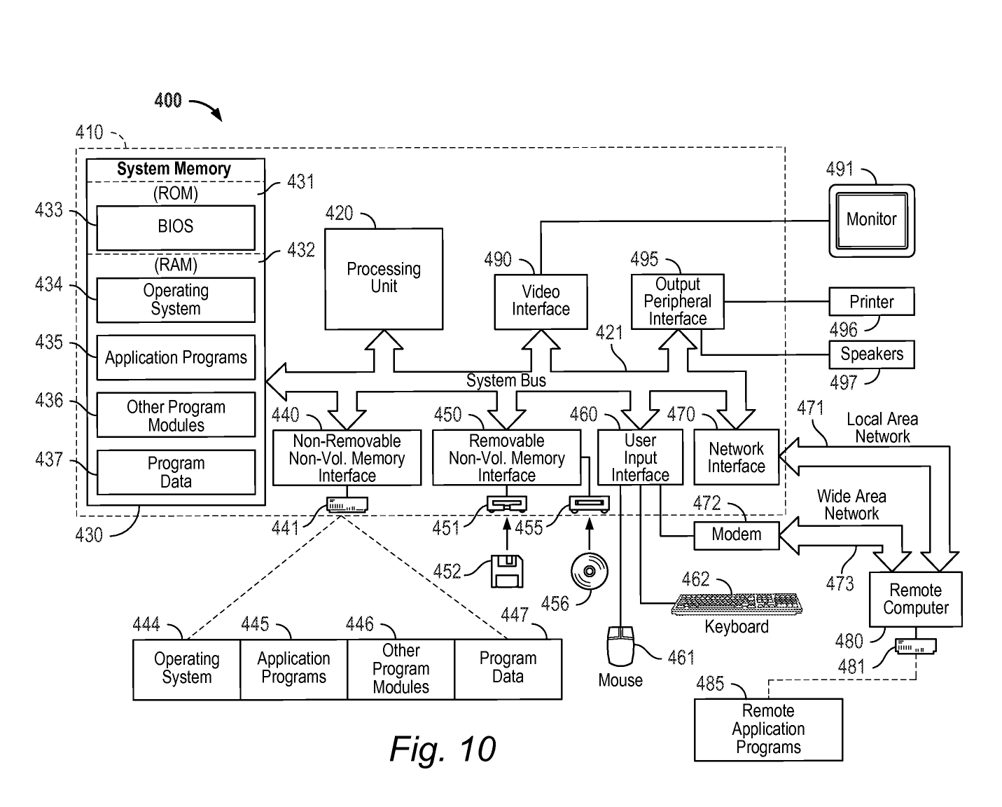

The present system will now be described with reference to FIGS. 4-10, which in general relate to synchronization in partial-replication systems. The system may be implemented on a distributed computing environment, including for example one or more desktop personal computers, laptops, handheld computers, personal digital assistants (PDAs), cellular telephones, multiprocessor systems, microprocessor-based systems, programmable consumer electronics, minicomputers, and/or other such computing system environments. Details relating to one such computing system environment are explained hereinafter with respect to FIG. 10. Two or more of the computing system environments may be continuously and/or intermittently connected to each other via a network such as peer-to-peer or other type of network as is known in the art.

Referring initially to FIGS. 4 and 5, the system includes a plurality of replicas 100, arbitrarily referred to herein as replicas A through E. Each replica 100 may create and/or modify a version of an item in a collection. A replica may be a computing system environment. However, multiple replicas may exist on a single computing system environment, and a single replica may exist across multiple computing system environments. Each replica 100 may include a data store 110 associated with a processor on one or more computing system environments mentioned above or as known in the art. Each data store 110 may store data associated with items in the collection and a knowledge vector, K, indicating which versions of an item the replica is aware of. Each replica 100 may additionally store a filter, F, to define a subset of items the replica is interested in receiving. The processor can modify an item to produce a new version, place versions into the data store 110 and can expunge versions from the data store 110.

In the example of FIG. 4, the replicas 100 may include a desktop computer A, a pair of laptop computers B and C, a cellular telephone D, a personal digital assistant (PDA) E and a digital camera F. The number and type of replicas comprising the collection shown in the figures is by way of example and there may be greater, fewer or different replicas in the collection than is shown. Moreover, the total membership of the collection does not necessarily need to be known to any given replica at any given time. Each replica in the sync community has a unique ID, which may be a global unique identifier (GUID) in one embodiment.

The replicas may communicate with each other in an ad hoc, peer-to-peer network via communication links 112 (represented by dashed lines) between the various replicas. It may be that not all replicas are linked to all other replicas. For example, laptop B is linked to desktop A, laptop C, cellular phone D, PDA E, but not digital camera F. Consequently, laptop B can sync with digital camera F only through one or more intermediate sync steps with replicas A and C through E. The illustrated communication links can be wired and/or wireless links, and may or may not include the Internet, a LAN, a WLAN or any of a variety of other networks.

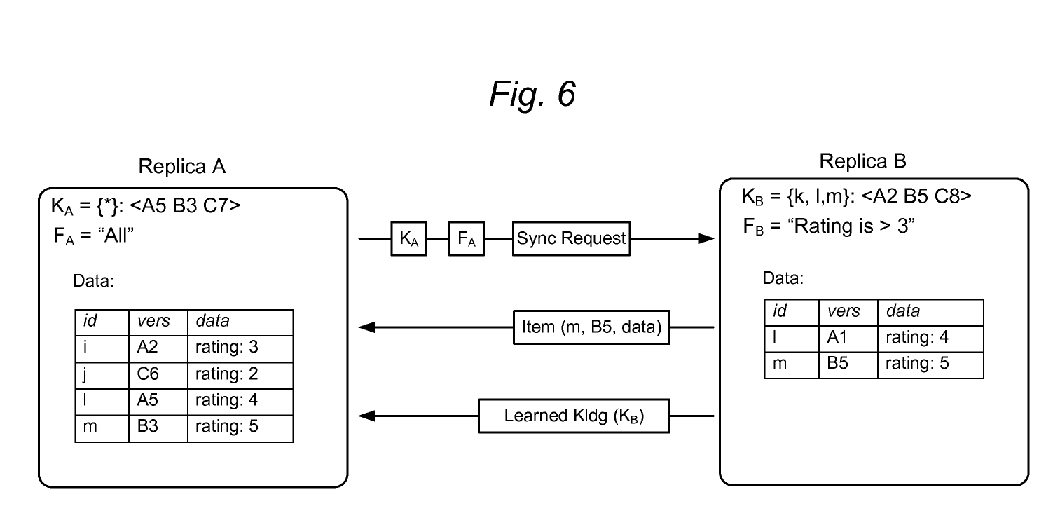

Referring now to FIG. 6, there is shown an example of replication between two replicas using a filter. The example shown in FIG. 6 is a one-way synchronization. Namely, there is an initiating replica requesting the sync (in this example, replica A), and a source replica which is contacted to provide updated information (in this example, replica B). In this example, replica B determines updated items replica A is not aware of, and transmits those updated items to replica A. From the point of view of transmitting items, replica B is the sending replica and replica A is the receiving replica.

While the figures and following description indicate a particular order of execution, the operations and/or their order may vary in alternative embodiments. For example, a pair of replicas could sync one-way, exchange roles, and sync the other way, thus performing a two-way synchronization. Furthermore, in some implementations, some or all of the steps may be combined or executed contemporaneously. In the example of FIG. 6, replica A includes knowledge K_{A} and a set of data items. Similarly, replica B includes knowledge K_{B} and a set of items.

In accordance with the present system, the concept of item-set knowledge, as explained below, may be used to sync partial replicas with low synchronization overhead. Partial replicas are those in which a filter may be specified or provided during a synchronization request. A filter is any construct that serves to identify a particular set of items of local interest to a replica and which get stored in a replica's data store. A filter may select items from the data collection based on their contents or metadata. A filter may be a SQL query over tabular data or an XPath expression over XML representations of items or any other type of content-based predicate.

An item may fall within a filter at one time, but due to a subsequent change in the item, may fall outside the filter at another time. An example would be as follows. Suppose a partial replica has a filter that selects “all movies having a rating of three or more stars” (where the number of stars represents the subjective rating of the movie). In this example, when using a replica in the collection, a user may ascribe a movie a rating of three stars. Thus, upon synchronization, the partial replica having the “3 or more stars rating” filter would accept this movie. However, subsequently, the user or another authorized user may downgrade the rating of the movie to two stars. At that time, the partial replica having the “3 or more stars rating” filter would want to learn that the downgraded movie was no longer of interest and it would not be interested in further updates, unless the movie was again upgraded to three stars or more.

In some embodiments, the filter itself may be transmitted as part of the sync request. In other embodiments, the filter may be stored elsewhere and only some means of identifying the filter may be transmitted as part of the sync request. In yet other embodiments, certain types of sync requests may automatically result in the use of certain filters, in which case the filter itself may not be transmitted with the sync request. For example, a sync request transmitted over a low bandwidth connection might automatically result in the use of a filter that in some way reduces the number or nature of the items or changes returned.

Item-set knowledge associates knowledge vectors with item-sets, instead of with the whole replica. Each replica stores one or more knowledge fragments consisting of an explicitly represented list of items and an associated knowledge vector as well as version numbers for each item similar to the knowledge vector scheme. Item-set knowledge represents an intermediate position between the two extreme cases of per-item version vectors and knowledge vectors in terms of space and bandwidth consumption. In the best case, the item-set knowledge may just require one fragment to cover the knowledge of all the items in the replica, while in the worst case, it may require a separate fragment for each item in the replica.

Each replica's knowledge is a set of knowledge fragments. Each knowledge fragment consists of two parts: an explicit set of items (indicated by their GUIDs) and an associated set of versions represented by a knowledge vector. In addition, the latest version number for each item needs to be maintained separately by the replica. This is similar to the case of knowledge vectors. The semantics are that, for any item in the item-set, the replica is aware of any versions included in the associated knowledge vector. Knowledge fragments are additive, i.e. a replica knows about a specific version of a specific item if any of its knowledge fragments includes the item in the item-set and the version in the associated knowledge vector. A knowledge vector may include versions for items that are not in the associated item-set, in which case nothing can be concluded about these versions.

As a special case, a knowledge fragment may refer to the universal set of all items without needing to list all possible GUIDs. Such a knowledge fragment is called “star knowledge”. Having star knowledge means that the replica is aware of all updates performed by each listed replica up to the corresponding version number in the knowledge vector.

A replica holds knowledge about items that it currently stores. This first type of knowledge is called “class I knowledge”. In addition, a partial replica may be aware of items that it does not store because the current version of the item is outside its scope of interest. This second type of knowledge is called “class II knowledge”. As an alternative embodiment, a partial replica may store a “place holder” to represent an item that is outside its scope of interest. In this alternative embodiment, knowledge of place holders corresponds to class II knowledge.

Without class II knowledge, an out-of-date sending replica could send the partial replica an old version of an item that subsequently was updated and removed from the partial replica's scope of interest. By maintaining class II knowledge, the partial replica remains aware of the update, even though it does not store the item, and thus can prevent the old version from reappearing in its data store.

Since no item is outside the scope of interest of a full replica, a full replica has no need for class II knowledge.

A replica initiating synchronization sends all of its knowledge fragments (both class I and class II) to the source replica, which returns, in addition to updated items, one or more knowledge fragments as learned knowledge.

When an item is created with a new version generated by the creating replica, this version is added to the replica's class I knowledge. If the replica has a single class I knowledge fragment, the process is straightforward. The new item's ID is added to the knowledge fragment's item-set and the new version is added to the fragment's knowledge vector. If the replica has multiple class I knowledge fragments, then several options are possible. One option is to create a new knowledge fragment for the new item. This may result in many small knowledge fragments. An alternative is to add the new item and version to all of the knowledge fragments. A still further alternative is to choose one knowledge fragment to which the new item is added. The fragment that is selected may be the one that has the largest item-set or the fragment with the maximal knowledge.

When an item is updated locally, the new version number is simply added to the knowledge vector of the knowledge fragment that includes the item in its item-set. Optionally, it could be added to all knowledge fragments. A partial replica can choose to discard any item that it stores. For example, a partial replica will generally discard items that are updated and no longer match its filter. In such a case, the ID of the discarded item could be simply removed from the item-set of the class I knowledge fragment(s) that contain this item. If the item-set is empty, i.e. it only contained this single item, then the whole knowledge fragment may be discarded. If the version of the removed item does not match the partial replica's filter, it may be retained as class II knowledge.

Replicas may change their filters. If a partial replica modifies its filter, i.e. changes the predicate that selects items of local interest, then in the general case it must discard all of its class II knowledge, because it has no way of knowing whether those items match its new filter or not. However, if the new filter is more restrictive than the old filter, meaning that all items excluded by the old filter are also excluded by the new filter, then the class II knowledge is still valid and need not be discarded.

At the end of a synchronization session, the sending replica transmits as learned knowledge all of its knowledge fragments. However, items that may match the filter predicate provided by the receiving replica but are not stored by the sending replica are removed from the item-sets of the learned knowledge fragments. In practice, this means that class II knowledge will not be returned as learned knowledge unless the sending replica is a full replica or is a partial replica whose filter matches anything that would be selected by the receiving replica's filter. Learned knowledge fragments that are received at the completion of a synchronization session are simply added to the receiving replica's knowledge. Redundant fragments can be discarded as discussed below.

Thus, referring now to FIG. 6, there is shown a replica A requesting a sync with a replica B. Each replica is said to have a knowledge fragment S:K, where S is an explicit set of items, or “*” for all items, indicating star knowledge. K is a knowledge vector. A knowledge fragment for a given replica, S:K, is interpreted as the given replica has knowledge about all versions in K for all items in S. Replica A is a full replica; that is, has no filter, with knowledge consisting of a single knowledge fragment:

K_{A}={*}: <A5 B3 C7>

representing knowledge about items i, j, l and m having various associated ratings 2 through 5. Furthermore, since this is star knowledge, replica A knows that no other items were created or updated by any of the replicas A, B, and C up to the corresponding version numbers 5, 3, and 7.

In the example of FIG. 6, replica B has a filter relating to the rating of items. In particular, replica B accepts items having a rating of >3. The items may relate to anything capable of being rated, such as for example data relating to movies, books, videos, etc. Replica B has a knowledge fragment:

K_{B}={l,m}: <A2 B5 C8>

representing knowledge about items l and m which have ratings >3.

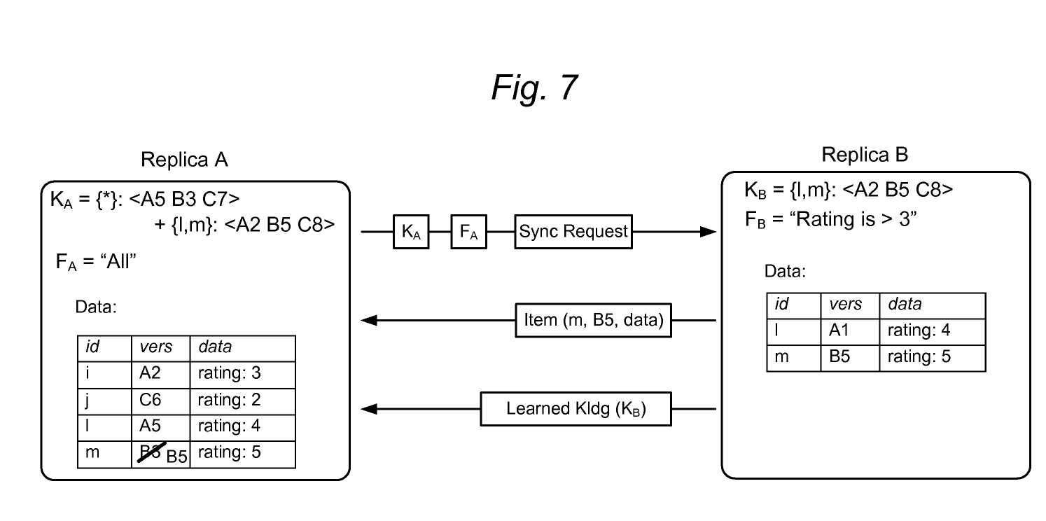

Upon requesting the sync, replica A sends its knowledge, K_{A} and its filter, F_{A}. Replica B learns that replica A is unaware of version B5 and determines that the item with this version matches replica A's filter. Therefore, replica B returns version B5 and associated data to replica A. As shown in FIG. 7, the version B3 in replica A is updated to B5. In the process of adding version B5 to its data store, replica A may detect an update conflict using known techniques for conflict detection. Known conflict resolution techniques may be applied in cases where neither update to a given item is the most recent.

Lastly, replica B returns the learned knowledge K_{B}. That is, as shown in FIG. 7, replica A learns about versions in K_{B} for items l and m. Thus after the sync, as shown in FIG. 7, replica A has two knowledge fragments:

K_{A}={*}: <A5 B3 C7>+{l,m}: <A2 B5 C8>.

This process may be repeated for each synchronization between replicas within the collection. In this example, replica B returned its complete knowledge as learned knowledge. However, in general, a replica should only return learned knowledge for items it stores that match the requesting replica's filter or for versions of items that it knows do not match the filter.

Synchronization between replicas may cause a replica's knowledge to partition into multiple knowledge fragments for subsets of items in the original item-set. For example, as seen in FIGS. 6 and 7, if replica A synchronizes with replica B interested in a subset of items of replica A's interest, then an item-set in replica A's knowledge may split into two sets, one covering the updates received from replica B and another for items not known to replica B.

Similarly, synchronization may cause multiple knowledge fragments to be discarded and/or merged into a single fragment with an item-set covering all the items in the original item-sets. For example, if replica B in the previous example synchronizes with replica A and replica A has a knowledge fragment that includes all of replica B's items with superior knowledge, then replica B could just replace its knowledge with the single fragment received from replica A. Table 2 below specifies how a replica may merge or reduce the size of two knowledge fragments, one knowledge fragment with item-set S₁ and knowledge vector K₁ and a second knowledge fragment with item-set S₂ and knowledge vector K₂.

TABLE 2
S₁:K₁ + S₂:K₂

[symbol]

| | S₁⊂S₂? | S₁ = S₂? | S₂⊂S₁? | S₁ [symbol] S₂? |
|---|---|---|---|---|
| K₁⊂K₂? | S₂:K₂ | S₂:K₂ | S₂:K₂ + S₁ − S₂:K₁ | S₂:K₂ + S₁ − S₂:K₁ |
| K₁ = K₂? | S₂:K₂ | S₁:K₁ | S₁:K₁ | S₁∪S₂:K₁ |
| K₂⊂K₁? | S₁:K₁ + S₂ − S₁:K₂ | S₁:K₁ | S₁:K₁ | S₁:K₁ + S₂ − S₁:K₂ |
| K₁ [symbol] K₂? | S₁:K₁∪K₂ + S₂ − S₁:K₂ | S₁:K₁∪K₂ | S₂:K₁∪K₂ + S₁ − S₂:K₁ | S₁:K₁ + S₂:K₂ |

Operations on S₁ and S₂ represent standard set operations and operations on K₁ and K₂ represent standard knowledge vector operations, except that ≠ is used to mean “incomparable”, that is, neither includes the other. Where K₂ properly includes K₁ (K₂ “dominates” K₁), and S₂ includes S₁, the S₁:K₁ knowledge fragment may be discarded and the result is S₂:K₂ (first row, first and second columns of table 2). Vice-versa where K₁ dominates K₂ and S₁ includes S₂ (third row, second and third columns). Where K₁ equals K₂ and S₂ dominates S₁, the resulting knowledge fragment is S₂:K₂ (second row, first column). Where K₁ equals K₂ and S₁ includes S₂, the resulting knowledge fragment is S₁:K₁ (second row, second and third columns). The remaining possible additive combinations result in some union or subtraction of either the items-sets or knowledge vectors, except for the case where K₁ and K₂ are incomparable and S₁ and S₂ are incomparable. In this case (fourth row, fourth column), there is no discard or merge and the resulting knowledge fragment is S₁:K₁+S₂:K₂. A union on two knowledge vectors (such as for example in the fourth row, first column) results in a new knowledge vector with the highest numbered version in the two vectors for each replica.

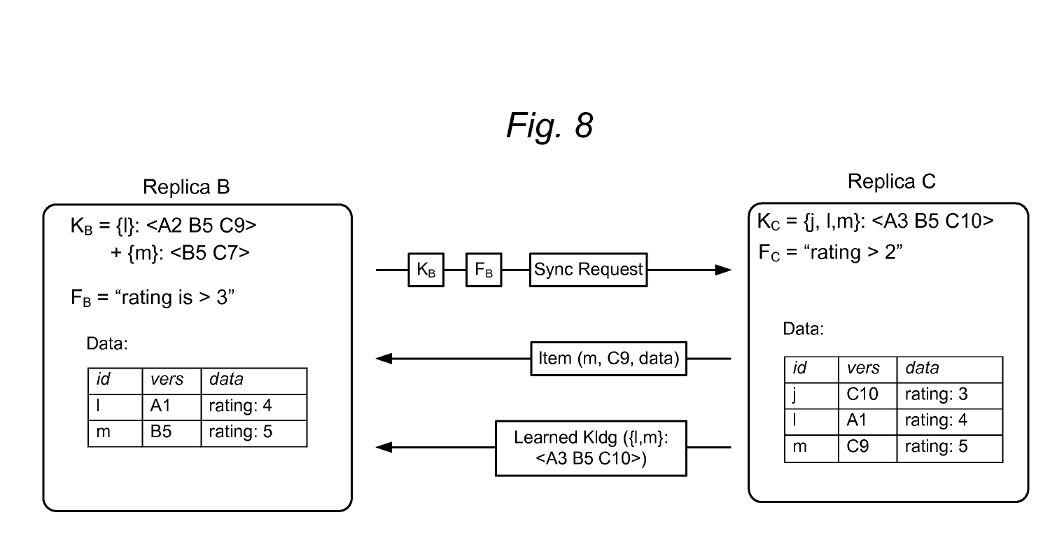

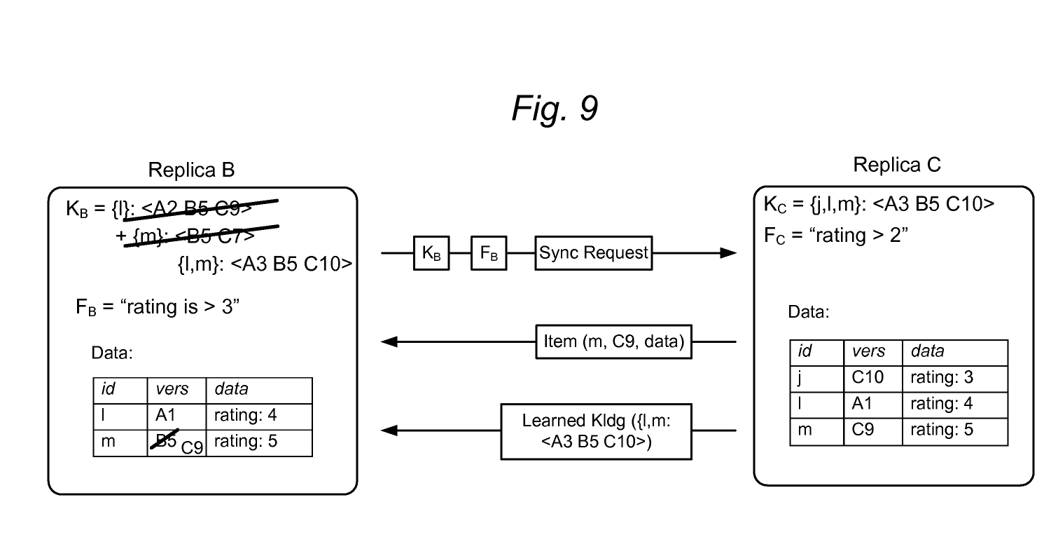

An example of item-set defragmentation using table 2 is shown in FIGS. 8 and 9. In this example, replica B syncs from replica C. Replica B has a filter F_{B} for items having a rating >3, and knowledge:

K_{B}={l}: <A2 B5 C9>+{m}: <B5 C7>

indicating that replica B has knowledge up to versions A2, B5 and C9 for item l, and knowledge up to versions B5 and C7 for item m. Replica C has a filter F_{C} for items having a rating >2, and knowledge:

K_{C}={j, l, m}: <A3 B5 C10>

indicating that replica C has knowledge up to versions A3, B5 and C10 for items j, l and m.

Upon requesting the sync, replica B sends its knowledge, K_{B} and its filter, F_{B}. Replica C learns that replica B is unaware of version C9, and returns version C9 and associated data to replica B. As shown in FIG. 9, the version B5 in replica B is updated to C9.

Lastly, replica C returns the learned knowledge {l, m}: <A3 B5 C10>. As item j has a rating of 3, and replica B's filter only receives items having a rating of >3, item j is not passed to replica B in the learned knowledge. Replica B learns about versions in K_{C} for items l and m. Replica B has two knowledge fragments: {l}: <A2 B5 C9> and {m}: <B5 C7>. Each of these are combined with the learned knowledge fragment from replica C separately using the table 2.

The learned knowledge fragment (hereafter referred to as S₂:K₂) combines with the first portion of the knowledge fragment S₁:K₁ per table 2 as follows:

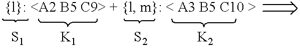

S₂ dominates S₁, i.e., S₂ contains all the items of S₁ and more, which is the first row of table 2. K₂ dominates K₁, i.e., K₂ contains all the versions in K₁ and more, which is the first column of table 2. The first row and column of table 2 indicate the additive result is S₂:K₂. Accordingly, the combination of the learned knowledge fragment S₂:K₂ with the first knowledge fragment S₁:K₁ results in S₂:K₂ or {l,m}: <A3 B5 C10>.

The learned knowledge fragment S₂:K₂ combines with replica B's second knowledge fragment per table 2 as follows:

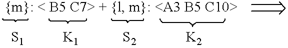

Again, S₂ dominates S₁, which is the first row of table 2. K₂ dominates K₁, which is the first column of table 2. The first row and column of table 2 again indicate the additive result is S₂:K₂. Accordingly, the combination of the learned knowledge fragment with replica B's second knowledge fragment results in {l,m}: <A3 B5 C10>.

The resulting knowledge for replica B K_{B} is thus:

{l,m}: <A3 B5 C10>+{l,m}: <A3 B5 C10>,

which, as shown in FIG. 9, simplifies under table 2 to just:

{l,m}: <A3 B5 C10>.

This process may be repeated for each sync between replicas within the collection to discard or merge knowledge fragments to keep synchronization overhead low.

As indicated above, replicas with knowledge of all items are said to have “star knowledge.” Conceptually, star knowledge is just an item set knowledge fragment U:K_{U} that covers the universal set U of items in the system; the set of items is implicit in the definition and need not be stored or communicated explicitly. Full replicas may represent their knowledge as a single star knowledge fragment, which avoids the need to explicitly list all of the items in the replicated data collection. Partial replicas can also use star knowledge in some cases. Star knowledge enables replicas to defragment item sets and ensure that the space and bandwidth consumed by item-sets remains low. Star knowledge may include the versions of items a partial replica is interested in keeping in its data store as well as versions of items the replica does not store and knows for sure fall outside its scope of interest. Note that replicas may have star knowledge in addition to other item-set knowledge fragments.

In embodiments, defragmentation involving a replica having star knowledge may take place according to table 3. This table shows how using star knowledge U:K_{U} leads to smaller or fewer item sets by illustrating a merge between item set S:K and U:K_{U}.

TABLE 3
S₁:K₁ + U:Kᵤ

[symbol]

| | S₁⊂U? | S₁ = U? |
|---|---|---|
| K₁⊂Kᵤ? | U:Kᵤ | U:Kᵤ |
| K₁ = Kᵤ? | U:Kᵤ | U:Kᵤ |
| Kᵤ⊂K₁? | S₁:K₁ + U:Kᵤ | U:K₁ |
| K₁ [symbol] Kᵤ? | S₁:K₁∪Kᵤ + U:Kᵤ | U:K₁∪Kᵤ |

The item sets in table 3 merge only when star knowledge is higher than the knowledge fragments in the item sets. Thus in order to continuously defragment split item sets, replicas need to accumulate recent star knowledge.

A method for accumulating star knowledge in a replication system is as follows: each replica speaks for itself in terms of star knowledge, that is, the latest version number issued by a replica represents the star knowledge component for that replica. A replica can accumulate star knowledge components for other replicas by individually synchronizing with every other replica and learning their most recent version numbers. For the above mechanism to work, replicas do not discard items it created or changed. Replicas also need to retain knowledge of discarded items, and not the items themselves, by keeping a place holder for discarded items or by keeping separate item sets to represent learned-knowledge for discarded items (called class-II knowledge). A replica may expunge a place holder or class-II knowledge of a discarded item only after ensuring that every other replica's star knowledge subsumes the current replica's version number in the discarded item's knowledge. More structured forms of synchronization are contemplated in alternative embodiments.

FIG. 10 illustrates an example of a suitable general computing system environment 400 for implementing a replica. It is understood that the term “computer” as used herein broadly applies to any digital or computing device or system. The computing system environment 400 is only one example of a suitable computing environment and is not intended to suggest any limitation as to the scope of use or functionality of the inventive system. Neither should the computing system environment 400 be interpreted as having any dependency or requirement relating to any one or combination of components illustrated in the exemplary computing system environment 400.

The inventive system is operational with numerous other general purpose or special purpose computing systems, environments or configurations. Examples of well known computing systems, environments and/or configurations that may be suitable for use with the inventive system include, but are not limited to, personal computers, server computers, multiprocessor systems, microprocessor-based systems, set top boxes, programmable consumer electronics, network PCs, minicomputers, mainframe computers, laptop and palm computers, hand held devices, distributed computing environments that include any of the above systems or devices, and the like.

With reference to FIG. 10, an exemplary system for implementing the inventive system includes a general purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 may include a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes volatile and nonvolatile, as well as removable and non-removable media implemented in any method or technology for storage of information such as computer readable instructions, data structures, program modules or other data. Computer storage media includes, but is not limited to, random access memory (RAM), read only memory (ROM), EEPROM, flash memory or other memory technology, CD-ROMs, digital versatile discs (DVDs) or other optical disc storage, magnetic cassettes, magnetic tapes, magnetic disc storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above are also included within the scope of computer readable media.

The system memory 430 includes computer storage media in the form of volatile and/or nonvolatile memory such as ROM 431 and RAM 432. A basic input/output system (BIOS) 433, containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 10 illustrates operating system 434, application programs 435, other program modules 436, and program data 437.

The computer 410 may also include other removable/non-removable, volatile/nonvolatile computer storage media. By way of example only, FIG. 10 illustrates a hard disc drive 441 that reads from or writes to non-removable, nonvolatile magnetic media and a magnetic disc drive 451 that reads from or writes to a removable, nonvolatile magnetic disc 452. Computer 410 may further include an optical media reading device 455 to read and/or write to an optical media.

Other removable/non-removable, volatile/nonvolatile computer storage media that can be used in the exemplary operating environment include, but are not limited to, magnetic tape cassettes, flash memory cards, DVDs, digital video tapes, solid state RAM, solid state ROM, and the like. The hard disc drive 441 is typically connected to the system bus 421 through a non-removable memory interface such as interface 440. Magnetic disc drive 451 and optical media reading device 455 are typically connected to the system bus 421 by a removable memory interface, such as interface 450.

The drives and their associated computer storage media discussed above and illustrated in FIG. 10, provide storage of computer readable instructions, data structures, program modules and other data for the computer 410. In FIG. 10, for example, hard disc drive 441 is illustrated as storing operating system 444, application programs 445, other program modules 446, and program data 447. These components can either be the same as or different from operating system 434, application programs 435, other program modules 436, and program data 437. Operating system 444, application programs 445, other program modules 446, and program data 447 are given different numbers here to illustrate that, at a minimum, they are different copies. A user may enter commands and information into the computer 410 through input devices such as a keyboard 462 and a pointing device 461, commonly referred to as a mouse, trackball or touch pad. Other input devices (not shown) may include a microphone, joystick, game pad, satellite dish, scanner, or the like. These and other input devices are often connected to the processing unit 420 through a user input interface 460 that is coupled to the system bus 421, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 10. The logical connections depicted in FIG. 10 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communication over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 10 illustrates remote application programs 485 as residing on memory device 481. It will be appreciated that the network connections shown are exemplary and other means of establishing a communication link between the computers may be used.

The foregoing detailed description of the inventive system has been presented for purposes of illustration and description. It is not intended to be exhaustive or to limit the inventive system to the precise form disclosed. Many modifications and variations are possible in light of the above teaching. The described embodiments were chosen in order to best explain the principles of the inventive system and its practical application to thereby enable others skilled in the art to best utilize the inventive system in various embodiments and with various modifications as are suited to the particular use contemplated. It is intended that the scope of the inventive system be defined by the claims appended hereto.

We claim:

1. A computer implemented method of synchronizing a plurality of replicas having a collection of items, the method comprising the steps of:
(a) receiving a sync request from a first replica at a second replica, said request containing a plurality of item-set knowledge fragments, said plurality of item-set knowledge fragments indicating versions of items of which the first replica is aware, one of said fragments referring to a plurality of items;
(b) transmitting from the second replica to the first replica versions of items which are not known to the first replica; and
(c) transmitting from the second replica to the first replica a plurality of item-set knowledge fragments, said plurality of item-set knowledge fragments indicating versions of items learned by the first replica, one of said fragments referring to a plurality of items.

2. A computer implemented method as recited in claim 1, further comprising defragmenting the result of the item-set knowledge fragments known to the first replica before said step (c) and the knowledge fragments received by the first replica in said step (c) to obtain knowledge fragments that are reduced in size or number.

3. A computer implemented method as recited in claim 2, wherein said step of defragmenting comprises the step of replacing a knowledge fragment in the first replica that existed prior to said step (c) with a knowledge fragment received in said step (c), where the knowledge fragment received in said step (c) dominates the knowledge fragment existing before said step (c).

4. A computer implemented method as recited in claim 2, wherein said step of defragmenting comprises the step of discarding a knowledge fragment received in said step (c) from the second replica where a knowledge fragment existing in the first replica prior to said step (c) dominates the knowledge fragment received in said step (c).

5. A computer implemented method as recited in claim 1, wherein a replica maintains a set of knowledge fragments for versions of items that it stores.

6. A computer implemented method as recited in claim 1, wherein a replica maintains a set of knowledge fragments for versions of items that it does not store.

7. A computer implemented method of synchronizing a plurality of replicas having a collection of items, the plurality including a first replica having a first set of items, and a second replica having a second set of items, the method comprising the steps of:
(a) associating a knowledge vector with the first set of items in the first replica to define a first knowledge fragment;
(b) associating a knowledge vector with the second set of items in the second replica to define multiple knowledge fragments;
(c) receiving a sync request from the first replica at the second replica;
(d) transmitting from the second replica to the first replica versions of items which are not known to the first replica; and
(e) transmitting from the second replica to the first replica the multiple knowledge fragments for addition to the first knowledge fragment.

8. A computer implemented method as recited in claim 7, wherein the second replica is a partial replica and the second set of items is a smaller subset of items than the general set of items in the collection.

9. A computer implemented method as recited in claim 7, wherein the first replica is a partial replica and the first set of items is a smaller subset of items than the general set of items in the collection.

10. A computer implemented method as recited in claim 9, wherein said step (d) of transmitting from the second replica to the first replica versions of items which are not known to the first replica comprises the step of transmitting versions of items that are not known to the first replica and which satisfy a filter applied within the second replica.

11. A computer implemented method as recited in claim 7, wherein said step (e) of transmitting from the second replica to the first replica the multiple knowledge fragments for addition to the first knowledge fragment comprises the step of defragmenting the additive result of the first knowledge fragment and the multiple knowledge fragments.

12. A computer implemented method of synchronizing between a collection of replicas having a set of items, the collection including a first replica having a first set of items, and a second replica having a second set of items, the method comprising the steps of:
(a) associating a knowledge vector, K₁, with the first set of items, S₁, in the first replica to define a first knowledge fragment, S₁:K₁;
(b) associating a knowledge vector, K₂, with the second set of items, S₂, in the second replica to define a second knowledge fragment, S₂:K₂;
(c) receiving a sync request from the first replica at the second replica;
(d) transmitting from the second replica to the first replica the second knowledge fragment for addition to the first knowledge fragment; and
(e) defragmenting the additive result of the first and second knowledge fragments obtained in said step (d).

13. A computer implemented method as recited in claim 12, wherein at least one of the first and second replicas are partial replicas.

14. A computer implemented method as recited in claim 12, wherein said step (e) of defragmenting the additive result of the first and second knowledge fragments comprises the step of discarding the S₁:K₁ knowledge fragment where K₁ is a subset of K₂, and S₁ is a subset of S₂ resulting in a knowledge fragment of S₂:K₂.

15. A computer implemented method as recited in claim 12, wherein said step (e) of defragmenting the additive result of the first and second knowledge fragments comprises the step of discarding the S₁:K₁ knowledge fragment where K₁ is a subset of K₂, and S₁ equals or is a subset of S₂ resulting in a knowledge fragment of S₂:K₂.

16. A computer implemented method as recited in claim 12, wherein said step (e) of defragmenting the additive result of the first and second knowledge fragments comprises the step of discarding the S₁:K₁ knowledge fragment where K₁ equals K₂, and S₁ is a subset of S₂ resulting in a knowledge fragment of S₂:K₂.

17. A computer implemented method as recited in claim 12, wherein said step (e) of defragmenting the additive result of the first and second knowledge fragments comprises the step of discarding the S₂:K₂ knowledge fragment where K₁ equals K₂, and S₂ is equal to or a subset of S₁ resulting in a knowledge fragment of S₁:K₁.

18. A computer implemented method as recited in claim 12, wherein said step (e) of defragmenting the additive result of the first and second knowledge fragments comprises the step of keeping S₁:K₁+S₂:K₂ as the resulting knowledge fragment where K₁ is not equal to K₂, and S₁ is not equal to S₁.

19. A computer implemented method as recited in claim 12, wherein the second replica is a partial replica and the second set of items is a smaller subset of items than the general set of items in the collection.

20. A computer implemented method as recited in claim 12, wherein the first replica is a partial replica and the first set of items is a smaller subset of items than the general set of items in the collection.
